(19) United States
(12) Patent Application Publication
(10) Pub. No.: US 2026/0179363 A1
(43) Pub. Date: Jun. 25, 2026

(54) SERVER AND INFORMATION PROCESSING DEVICE

(71) Applicants: TOYOTA JIDOSHA KABUSHIKI KAISHA, Toyota-shi (JP); DENSO TEN Limited, Kobe (JP)

(72) Inventor: Kimitaka MURASHITA, Kobe (JP)

(73) Assignees: TOYOTA JIDOSHA KABUSHIKI KAISHA, Toyota-shi (JP); DENSO TEN Limited, Kobe (JP)

(21) Appl. No.: 19/371,644

(22) Filed: Oct. 28, 2025

(30) Foreign Application Priority Data
Nov. 12, 2024 (JP) 2024-197693

(51) Int. Cl. G06V 10/774; G06V 10/98; G06V 20/56

(52) U.S. Cl. CPC G06V 10/774; G06V 10/98; G06V 20/56

(57) ABSTRACT

A server includes: a storage unit configured to store an AI model configured to detect a recognition target from a captured image; and a control unit configured to output information indicating that the recognition target has changed, when a condition is satisfied that the number of locations at which the recognition target that had previously been recognizable is no longer recognizable is greater than a first threshold.

### CROSS-REFERENCE TO RELATED APPLICATION

This application claims priority to Japanese Patent Application No. 2024-197693 filed on Nov. 12, 2024. The disclosure of the above-identified application, including the specification, drawings, and claims, is incorporated by reference herein in its entirety.

### BACKGROUND

### 1. Technical Field

The present disclosure relates to servers and information processing devices.

### 2. Description of Related Art

Conventionally, techniques have been known for selecting training data that contributes to improving model inference results with low computational load. For example, Japanese Unexamined Patent Application Publication No. 2024-073155 (JP 2024-073155 A) discloses a training data selection device that includes an information addition unit and an image selection unit. The information addition unit adds metadata to captured images of a storage area where articles are stored. The metadata includes (i) environmental information of the storage area that affects the difficulty of recognizing the articles included in the captured images, (ii) image clarity information related to the resolution of the images, and/or (iii) inference information based on the output of a model that recognizes the articles. The image selection unit selects, based on the metadata, images stored in a storage unit in which a plurality of images with the metadata added thereto are stored.

### SUMMARY

The technique described in JP 2024-073155 A selects training data based on the difficulty of recognizing articles. However, this technique is based on the premise that the articles are recognizable, and does not consider cases where articles that had previously been recognizable are no longer recognizable. For example, if a stored article is contained in a box and the design of the box has changed, the article may no longer be recognizable. When such a design change or the like occurs, the operator must visually confirm the design change, collect image data of the new design to create training data, and update (retrain) the model using the training data.

In view of the above circumstances, an object of the present disclosure is to enable automatic detection of changes in recognition targets caused by environmental changes.

A server according to one embodiment of the present disclosure includes: a storage unit configured to store an AI model configured to detect a recognition target from a captured image; and a control unit configured to output information indicating that the recognition target has changed, when a condition is satisfied that the number of locations at which the recognition target that had previously been recognizable is no longer recognizable is greater than a first threshold.

An information processing device according to one embodiment of the present disclosure includes: a storage unit configured to store an AI model received from a server; a control unit configured to input a captured image, captured by an onboard camera, into the AI model, perform recognition of a recognition target, and, when the recognition target is not successfully recognized from the captured image, determine whether an imaging condition of the captured image matches an imaging condition under which the recognition target was previously successfully recognized; and a communication unit configured to, when the recognition target is not successfully recognized from the captured image and the imaging condition matches the imaging condition under which the recognition target was previously successfully recognized, transmit, to the server, the imaging condition, the captured image in which the recognition target is not successfully recognized, and information indicating that the recognition target is no longer recognizable under the imaging condition under which the recognition target was previously successfully recognized.

One embodiment of the present disclosure enables automatic detection of changes in recognition targets caused by environmental changes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of the configuration of an image recognition system according to an embodiment;

FIG. 2 is a flowchart illustrating an example of a processing procedure performed by a vehicle according to an embodiment; and

FIG. 3 is a flowchart illustrating an example of a processing procedure performed by a server according to an embodiment.

### DETAILED DESCRIPTION OF EMBODIMENTS

### Configuration of Image Recognition System

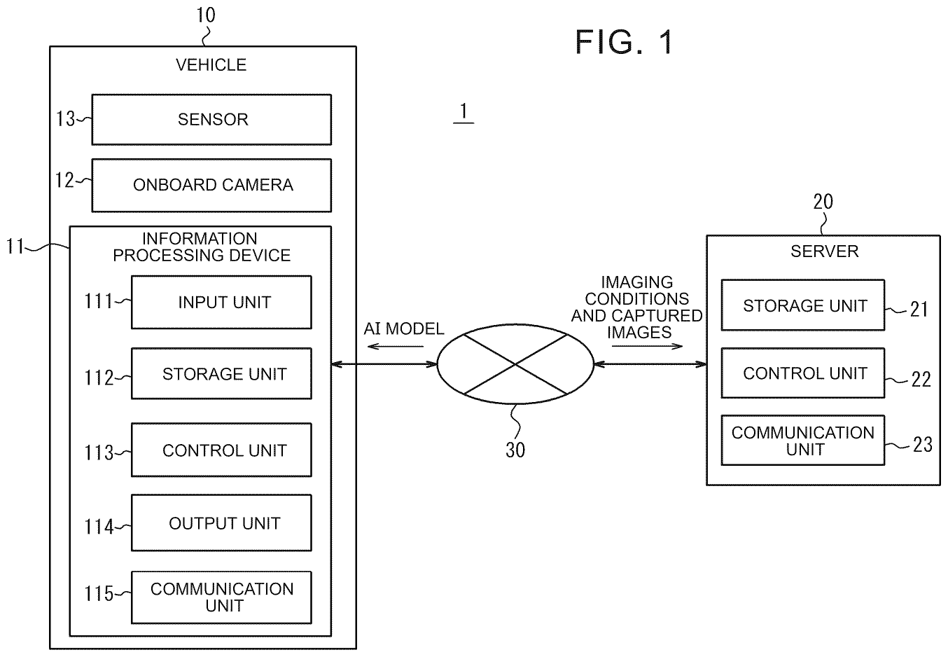

The configuration of an image recognition system according to an embodiment will be described with reference to FIG. 1. An image recognition system 1 includes a plurality of vehicles 10 and a server 20. For convenience, only one vehicle is shown in FIG. 1. The vehicles 10 and the server 20 are communicably connected to each other via a network 30. The network 30 includes the Internet. The server 20 may be either a cloud-based server or an on-premises server. Each vehicle 10 includes an information processing device 11, an onboard camera 12, and a sensor 13.

The onboard camera 12 is a camera mounted on the vehicle 10. A plurality of such cameras may be mounted on the vehicle 10. The onboard camera 12 is connected to the information processing device 11. The onboard camera 12 may be integrated with the information processing device 11. The onboard camera 12 includes an imaging element and captures images of the surroundings of the vehicle 10 while the vehicle 10 is traveling.

The sensor 13 includes a satellite positioning sensor that receives satellite signals from a Global Navigation Satellite System (GNSS) such as Global Positioning System (GPS) and measures the position, orientation, heading, and current time of the vehicle 10.

The information processing device 11 is a device mounted on the vehicle 10, and performs wireless communication with the server 20. The information processing device 11 includes an input unit 111, a storage unit 112, a control unit 113, an output unit 114, and a communication unit 115.

The input unit 111 includes at least one input interface. The input interface may be, for example, a physical key, a capacitive key, a pointing device, a touchscreen integrated with a display, or a microphone. The input unit 111 also includes an interface with the onboard camera 12, and receives images captured by the onboard camera 12 (hereinafter referred to as “captured images”).

The storage unit 112 includes at least one semiconductor memory, at least one magnetic memory, at least one optical memory, or any combination thereof. The semiconductor memory may be, for example, a random access memory (RAM), a read-only memory (ROM), or a flash memory. The storage unit 112 stores imaging conditions and captured images. The storage unit 112 also stores an artificial intelligence (AI) model for detecting recognition targets from captured images. The AI model may be either a machine learning model or a deep learning model.

The output unit 114 includes at least one output interface. The output interface may be, for example, a display that outputs information as visual images, or a speaker that outputs information as sound. The display may be, for example, a liquid crystal display (LCD) or an organic electroluminescence (EL) display.

The communication unit 115 includes a wireless communication interface for performing wireless communication with the server 20. The communication unit 115 receives an AI model from the server 20. The communication unit 115 also transmits imaging conditions and captured images to the server 20.

The control unit 113 includes a processor (e.g., a general-purpose processor such as a central processing unit (CPU) or a graphics processing unit (GPU), or a dedicated processor specialized for specific processing), a programmable circuit (e.g., a field-programmable gate array (FPGA)), a dedicated circuit (e.g., an application-specific integrated circuit (ASIC)), or any combination thereof. The control unit 113 controls each component of the information processing device 11 and performs processing related to the operation of the information processing device 11.

The server 20 is a server that performs wireless communication with the information processing device 11, and includes a storage unit 21, a control unit 22, and a communication unit 23.

The storage unit 21 includes at least one semiconductor memory, at least one magnetic memory, at least one optical memory, or any combination thereof. The storage unit 21 stores a machine learning model for detecting recognition targets from captured images. The storage unit 21 also stores imaging conditions and captured images.

The control unit 22 includes at least one processor, at least one programmable circuit, at least one dedicated circuit, or any combination thereof. The control unit 22 controls each component of the server 20 and performs processing related to the operation of the server 20.

The communication unit 23 includes a wireless communication interface for performing wireless communication with the information processing device 11. The communication unit 23 transmits an AI model to the information processing device 11. The communication unit 23 also receives imaging conditions and captured images from the information processing device 11.

In the present embodiment, the description is provided using an illustrative example in which the recognition target is a gas station sign. The image recognition system 1 detects the gasoline price from a captured image including the gas station sign and provides a map displaying the location of the gas station and the gasoline price. To realize this service, the server 20 stores an AI model trained using captured images including gas station signs as labeled training data, and updates the AI model in response to environmental changes, as described below.

The control unit 113 of the information processing device 11 inputs captured images into the AI model and detects a gas station sign. Then, using existing recognition technologies such as optical character recognition/reader (OCR), the control unit 113 recognizes a three-digit number as the gasoline price from the captured images including the gas station sign. Since the three-digit number is extracted from images showing a gas station sign, it is unlikely that numbers other than the gasoline price will be erroneously recognized. However, the number of digits of the number to be detected is not limited to three digits, and may be changed according to the market price conditions (price range) of gasoline or the market price conditions of gasoline in the region where image recognition is performed. The control unit 22 of the server 20 maps the gasoline price recognized by the information processing device 11 onto a map together with an image or icon of the gas station sign and stores the resulting map in the storage unit 21. Alternatively, the control unit 22 of the server 20 may detect the gasoline price from captured images received from the vehicle 10.

### Operation Example

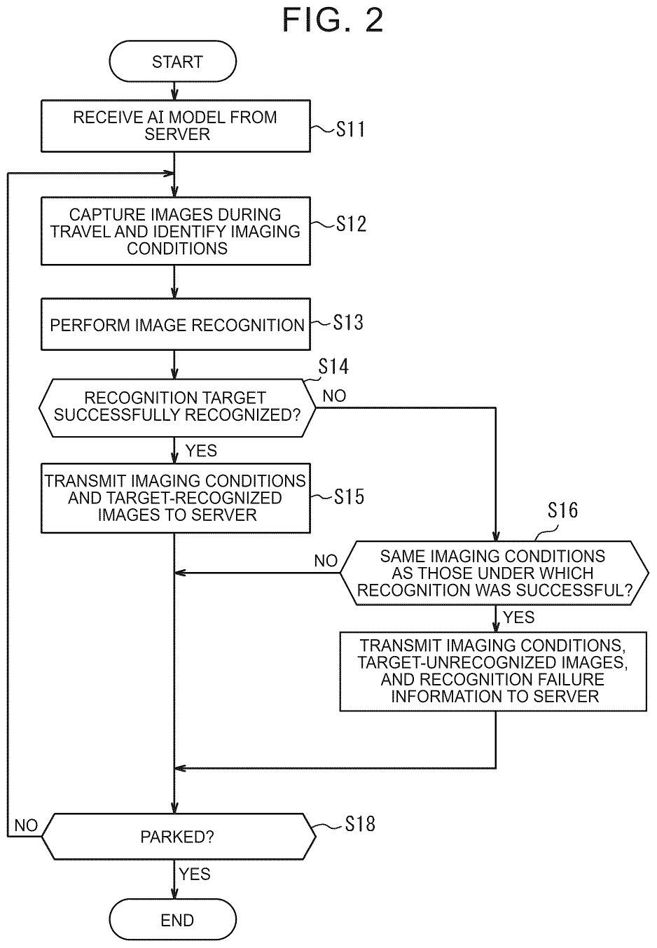

Next, an example of a processing procedure performed by the vehicle 10 will be described with reference to FIG. 2. FIG. 2 is a flowchart illustrating the operation of the information processing device 11. The information processing device 11 performs the steps shown in FIG. 2 when the vehicle 10 is powered on. Specifically, the control unit 113 implements the steps by controlling the input unit 111, the storage unit 112, the output unit 114, and the communication unit 115.

In step S11, the information processing device 11 receives (downloads) the latest AI model from the server 20 and stores it in the storage unit 112. For example, the information processing device 11 transmits a request signal to the server 20 to request transmission of the latest AI model (an AI model for recognizing the recognition target), receives the AI model sent from the server 20 in response to the request signal, and stores it in the storage unit 112. The latest AI model may be received (acquired) whenever appropriate, for example once a week, instead of each time the vehicle 10 is powered on, as long as the operation using the AI model is not adversely affected.

In step S12, the information processing device 11 obtains captured images from the onboard camera 12. At the time of step S12, the information processing device 11 has already set the onboard camera 12 to an operational state (i.e., an activated state) in which it captures external images while the vehicle 10 is traveling.

In step S12, the information processing device 11 obtains (identifies) the imaging conditions at the time the onboard camera 12 captures images, and stores them in the storage unit 112. The imaging conditions refer to information including the position (imaging position) and orientation (imaging direction) of the vehicle 10 obtained from the sensor 13. In some cases, the recognition target may or may not be recognizable depending on the weather. Therefore, the imaging conditions may include information indicating the weather. Such weather information may be either obtained from an external device such as a weather data server, or recognized from the captured images. In addition, the recognition target may or may not be recognizable depending on the time at which the image is captured (e.g., brightness or sunlight). Accordingly, the imaging conditions may include information indicating the current time obtained from the sensor 13. The imaging conditions may also include information indicating the direction of travel of the vehicle 10 obtained from the sensor 13.

In step S13, the information processing device 11 inputs the captured images into the AI model and performs recognition of the recognition target.

In step S14, the information processing device 11 determines whether the recognition target was successfully recognized from the captured images. When the recognition is successful, the process proceeds to step S15. Otherwise, the process proceeds to step S16.

In step S15, the information processing device 11 transmits (uploads) the imaging conditions and the captured images in which the recognition target was successfully recognized (hereinafter referred to as “target-recognized images”) to the server 20. The communication unit 115 may transmit part of the imaging conditions, for example, the imaging position information, to the server 20. The information processing device 11 stores the imaging conditions in the storage unit 112.

In step S16, the information processing device 11 compares the current imaging conditions with past imaging conditions, among those stored in the storage unit 112, under which the recognition target was successfully recognized. When the current imaging conditions match the past imaging conditions, the process proceeds to step S17. Otherwise, the process proceeds to step S18. For example, the process proceeds to step S18 in cases where there are no past images captured under the same imaging conditions, or where the recognition target could not be recognized even in past images captured under the same imaging conditions.

In step S17, the information processing device 11 transmits (uploads) the following to the server 20: the imaging conditions; the captured images in which the recognition target could not be recognized (hereinafter referred to as “target-unrecognized images”); and information indicating that the recognition target, which had previously been recognizable under the same imaging conditions, is no longer recognizable (hereinafter referred to as “recognition failure information”). The information processing device 11 may transmit part of the imaging conditions, for example, the imaging position information, to the server 20.

In step S18, the information processing device 11 ends the process when the vehicle 10 is parked. When the vehicle 10 is still operating, the process returns to step S12 and repeats the steps described above. For example, the parking of the vehicle 10 may be detected based on the engine of the vehicle 10 being turned off.

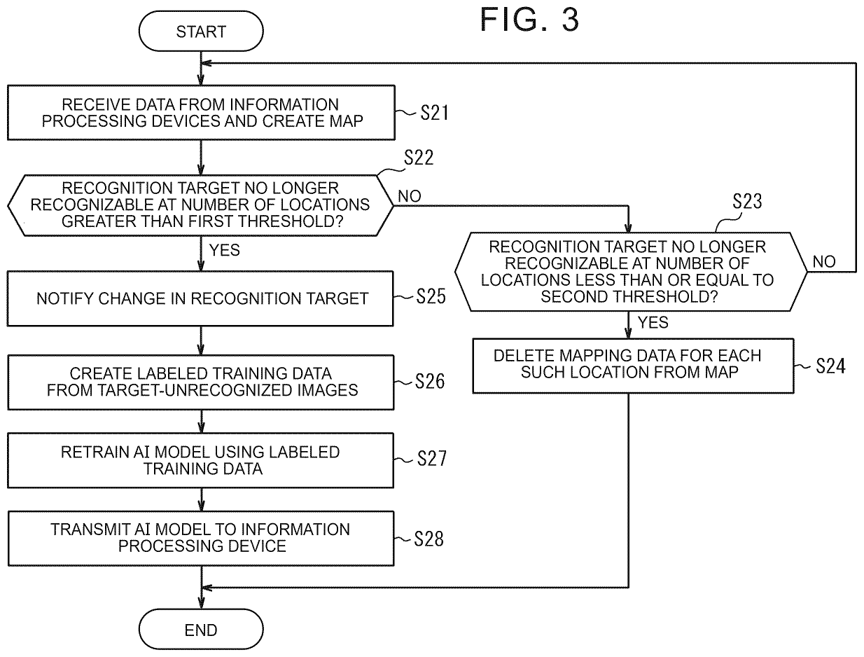

Next, an example of a processing procedure performed by the server 20 will be described with reference to FIG. 3. FIG. 3 is a flowchart illustrating a process performed by the server 20. The process shown in FIG. 3 is performed at a timing appropriate for verifying or updating the suitability of the AI model, such as once per day. That is, when circumstances change, such as when a new recognition target emerges or when the appearance or form of a recognition target changes, the recognition performance of the AI model may degrade. Therefore, this process is performed when a change in circumstances occurs to an extent that the impact of the degraded recognition performance of the AI model can no longer be ignored. Specifically, the control unit 22 implements the steps by controlling the storage unit 21 and the communication unit 23.

In step S21, the server 20 reads, from the storage unit 21, the imaging conditions, the target-recognized images, the target-unrecognized images, and the recognition failure information, all of which have been received from the information processing devices 11 of the vehicles 10 and stored in the storage unit 21. More specifically, the server reads, from the storage unit 21, the data received from the multiple information processing devices 11 since the previous retraining of the AI model. The server 20 continuously receives these types of data from the information processing devices 11 and stores them in the storage unit 21. The control unit 22 either receives gasoline price information directly from the information processing devices 11 or detects gasoline prices from the target-recognized images, identifies the locations of gas stations based on the imaging positions and imaging directions, and creates a map in which data such as images or icons of gas station signs and gasoline prices are mapped.

In step S22, the server 20 determines, based on the data read from the storage unit 21 in step S21, whether the following condition is satisfied: that the recognition target that had previously been recognizable under the same imaging conditions is no longer recognizable at a (large) number of locations greater than a first threshold Th1. In other words, it is determined whether there are many locations where the recognition target is no longer recognizable. Specifically, the control unit 22 counts the number of gas station locations at which the gas station sign is no longer recognizable, based on the imaging positions of the “target-unrecognized images” contained in the data read from the storage unit 21, and determines whether this count is greater than the first threshold Th1. The first threshold Th1 may be set to an appropriate value based on experiments (simulations) or the like. When the condition is satisfied, the process proceeds to step S25. Otherwise, the process proceeds to step S23.

In step S23, the server 20 determines, based on the data read from the storage unit 21 in step S21, whether the following condition is satisfied: that the recognition target that had previously been recognizable under the same imaging conditions is no longer recognizable at a number of locations less than or equal to a second threshold Th2 (Th2<Th1). When the condition is satisfied (i.e., the recognition target is no longer recognizable at a limited (small) number of locations), the process proceeds to step S24. Otherwise, the process returns to step S21. The processes of steps S22, S23 are configured based on the following technical idea: when the recognition target is no longer recognizable at a large number of locations, it is highly likely that the AI model should be updated due to, for example, a design change in the recognition target (that is, the performance of the AI model has degraded), and when the recognition target is no longer recognizable at a small number of locations, it is more likely that the recognition target itself is no longer present at those locations. Accordingly, the subsequent process is changed based on this determination.

In step S24, the server 20 deletes the mapping data (mapped in step S21) for each such location from the map. That is, for each location where the recognition target is no longer recognizable, it is regarded that the facility such as a store associated with the recognition target (e.g., a gas station) has been closed down or changed, and the facility such as a store associated with the recognition target at that location is deleted from the map.

In step S25, the server 20 determines that the recognition target has changed at each location where it is no longer recognizable. The control unit 22 then outputs information indicating the change in the recognition target along with the target-unrecognized images, thereby notifying the operator (e.g., the administrator of the server 20). The change in the recognition target may include, for example, a change in the logo (design or character string) of the recognition target. Upon receiving this notification, the operator informs the person in charge of updating the AI model of the change. The operator and the person in charge of updating the AI model may be the same person. The AI model can be updated either automatically or manually.

In step S26, the server 20 collects the target-unrecognized images received from the information processing devices 11. These target-unrecognized images are images that include the recognition target after the change. The server 20 uses the collected target-unrecognized images as labeled training data. Specifically, the control unit 22 creates labeled training data by annotating the collected target-unrecognized images (i.e., adding correct answer labels to them). The operator may identify the new recognition target and create labeled training data, or an annotation service provided by a cloud platform may be used.

In step S27, the server 20 retrains (updates) the AI model using the labeled training data created in step S26 together with the labeled training data previously used for training (learning).

In step S28, the server 20 transmits the updated new AI model to the information processing devices 11. Each information processing device 11 receives the new AI model, stores it in the storage unit 112, and uses it for recognition processing of the recognition target. Through the above processing, the server 20 is able to automatically detect changes in recognition targets. The server 20 retrains the AI model, which has become outdated over time, by using training data including images of the recognition target after the change. It is therefore possible to update the AI model such that it can recognize the recognition target after the change.

A computer capable of executing programs may be used to implement the functions of the information processing device 11 and server 20. The programs can be stored in a non-transitory computer-readable medium.

What is claimed is:

1. A server comprising:
a storage unit configured to store an AI model configured to detect a recognition target from a captured image; and
a control unit configured to output information indicating that the recognition target has changed, when a condition is satisfied that the number of locations at which the recognition target that had previously been recognizable is no longer recognizable is greater than a first threshold.

2. The server according to claim 1, wherein the control unit configured to, when the condition is satisfied, collect images including the recognition target that has changed, and update the AI model using the images as training data.

3. The server according to claim 1, wherein:
the control unit is configured to create a map in which a position of the recognition target is mapped; and
the control unit is configured to, when a condition is satisfied that the number of locations at which the recognition target that had previously been recognizable is no longer recognizable is less than or equal to a second threshold, delete mapping data for the location from the map, the second threshold being less than or equal to the first threshold.

4. An information processing device comprising:
a storage unit configured to store an AI model received from a server;
a control unit configured to input a captured image, captured by an onboard camera, into the AI model, perform recognition of a recognition target, and, when the recognition target is not successfully recognized from the captured image, determine whether an imaging condition of the captured image matches an imaging condition under which the recognition target was previously successfully recognized; and
a communication unit configured to, when the recognition target is not successfully recognized from the captured image and the imaging condition matches the imaging condition under which the recognition target was previously successfully recognized, transmit, to the server, the imaging condition, the captured image in which the recognition target is not successfully recognized, and information indicating that the recognition target is no longer recognizable under the imaging condition under which the recognition target was previously successfully recognized.

5. The information processing device according to claim 4, wherein the communication unit is configured to, when the recognition target is successfully recognized from the captured image, transmit, to the server, the imaging condition of the captured image and the captured image in which the recognition target is successfully recognized.

6. The information processing device according to claim 5, wherein the imaging condition is information including a position of a vehicle on which the onboard camera is mounted and orientation of the vehicle.
